(19) United States
(12) Patent Application Publication
(10) Pub. No.: US 2026/0026552 A1
(43) Pub. Date: Jan. 29, 2026

(54) ELECTRONIC CIRCUIT FOR AN AEROSOL GENERATOR OF AN AEROSOL PROVISION DEVICE

(71) Applicant: NICOVENTURES TRADING LIMITED, London (GB)

(72) Inventors: Michael THOMAS, London (GB); Andrew SUTTON, London (GB); Karthik Raj GURUCHANDRAN, Hampshire (GB)

(21) Appl. No.: 19/107,193

(22) PCT Filed: Aug. 25, 2023
(86) PCT No.: PCT/EP2023/073381

§ 371 Date: Feb. 27, 2025

(30) Foreign Application Priority Data
Aug. 31, 2022 (GB) 2212636.1

(51) Int. Cl. A24F 40/465; A24F 40/20; A24F 40/51; A24F 40/53; A24F 40/57; A24F 40/90

(52) U.S. Cl. CPC A24F 40/465; A24F 40/20; A24F 40/51; A24F 40/53; A24F 40/57; A24F 40/90

(57) ABSTRACT

An electronic circuit for an aerosol generator of an aerosol provision device including a driver arrangement arranged in a H-bridge configuration for supplying an alternating current to an aerosol generator having one or more first induction elements and one or more second induction elements; and a switch element arranged to switch the alternating current supplied by the driver arrangement to either the one or more first induction elements or the one or more second induction elements.

### RELATED APPLICATIONS

The present application is a National Phase entry of PCT Applicant No. PCT/EP2023/073381 filed Aug. 25, 2023, which claims priority to GB Application No. 2212636.1 filed Aug. 31, 2022, each of which is hereby incorporated by reference in their entirety.

### TECHNICAL FIELD

The present invention relates to an electronic circuit for an aerosol generator of an aerosol provision device, an aerosol provision device, an aerosol generating system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

It is known to provide an aerosol provision device comprising an aerosol generator comprising two induction coils.

It is desired to provide an improved electronic circuit for an aerosol generator.

### SUMMARY

According to an aspect there is provided an electronic circuit for an aerosol generator of an aerosol provision device comprising:
a driver arrangement arranged in a H-bridge configuration for supplying an alternating current to an aerosol generator comprising one or more first induction elements and one or more second induction elements; and
a switch element arranged to switch the alternating current supplied by the driver arrangement to either the one or more first induction elements or the one or more second induction elements.

According to various embodiments an electronic circuit for an aerosol generator or an aerosol provision device is provided comprising a driver arrangement arranged in a H-bridge configuration for supplying an alternating current to an aerosol generator comprising one or more first induction elements and one or more second induction elements. The induction elements may comprise, for example, a coil or an induction coil. An H-bridge configuration is a specific configuration which is arranged to switch the polarity of a voltage applied to a load. In the context of an aerosol provision device, an H-bridge configuration is an arrangement wherein a DC voltage from a DC battery is applied to the terminals of an induction element in a manner in which the direction of flow of the DC current is repeatedly reversed. As a result, an alternating current is applied to the terminals of the induction element. The electronic circuit further comprises a switch element, such as a MOSFET, arranged to switch the alternating current supplied by the driver arrangement to either the one or more first induction elements or the one or more second induction elements. Such an electronic circuit allows two or more induction elements located in different sections or zones of an aerosol generator to be driven by a single driver arrangement. It will be understood, that conventionally an aerosol generator comprising two induction elements will require two separate driver arrangements, one for each induction element.

According to various embodiments the use of a single H-bridge driver arrangement to drive multiple induction elements results in the provision of a simpler electronic circuit. It will be understood that a driver arrangement arranged in a full H-bridge configuration requires a number of discrete electronic components (such as MOSFETs) to be provided and that these electronic components will require a relatively large surface area to be provided on a printed circuit board (PCB). As a result, a conventional electronic circuit comprising two full H-bridge drivers in order to supply an alternating current to two induction elements will require a relatively large PCB. However, it will also be understood that it is desirable to provide a compact aerosol provision device. Therefore, an electronic circuit which comprises a single full H-bridge driver arrangement for driving two or more induction elements results in space spacing and enables a PCB with a smaller footprint to be utilized. As a result, a more compact aerosol provision device can be provided. A yet further benefit of using a single driver according to various embodiments in order to supply an alternating current to multiple induction elements is that the electronic circuit may have a lower energy requirement and hence the battery life of the aerosol provision device can be extended.

It will be understood, therefore, that an electronic circuit comprising e.g. a single full H-bridge driver for supplying an alternating current to multiple induction elements in combination with a switch element is particularly beneficial in that it enables a smaller footprint PCB to be utilized with a lower energy requirement which in turn enables a more compact aerosol provision device to be provided which is also capable of performing a greater number of sessions before the battery of the aerosol provision device needs re-charging.

Optionally, the switch element comprises a MOSFET.

According to another aspect there is provided an aerosol provision device comprising: an electronic circuit as described above.

Optionally, the aerosol provision device further comprises an aerosol generator.

Optionally, the aerosol generator comprises one or more first induction elements and one or more second induction elements.

Optionally, the one or more first induction elements comprise one or more induction coils.

Optionally, the one or more second induction elements comprises one or more induction coils.

According to another aspect there is provided an aerosol generating system comprising:
an aerosol provision device as described above; and
an aerosol generating article comprising aerosol generating material.

According to another aspect there is provided a method of generating an aerosol comprising:
providing an aerosol provision device as described above;
inserting an aerosol generating article comprising aerosol generating material into the aerosol provision device; and
energizing the aerosol generating article.

### BRIEF DESCRIPTION OF THE DRAWINGS

Various embodiments will now be described, by way of example only, together with other arrangements given for illustrative purposes only and with reference to the accompanying drawings in which:

FIG. 1 shows for illustrative purposes an electronic circuit of an aerosol provision device comprising two induction coils and shows an aerosol generating article located within a heating chamber of the aerosol provision device, wherein each induction coil is driven by a separate driver arrangement;

FIG. 2 shows for illustrative purposes a portion of an electronic circuit of an aerosol provision device wherein two induction coils are each driven by separate H-bridge driver circuits; and

FIG. 3 illustrates a driver arrangement according to various embodiments, wherein the driver arrangement is arranged to supply an alternating current to an aerosol generator comprising one or more first induction elements and one or more second induction elements wherein a switch element switches the alternating current supplied by the driver arrangement to either the one or more first induction elements or the one or more second induction elements so that a single driver arrangement is arranged to supply an alternating current to multiple induction elements.

### DETAILED DESCRIPTION

Induction heating is a process of heating an electrically conducting object (or susceptor) by electromagnetic induction. An induction heater may comprise an induction element, such as one or more coils or an electromagnet (coils may be part of an electromagnet), and circuitry for passing a varying electric current, such as an alternating electric current, through the one or more coils. The varying electric current in the coils produces a varying magnetic field. The varying magnetic field penetrates a susceptor suitably positioned with respect to the one or more coils, generating eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor i.e. by the varying orientation of magnetic dipoles in the magnetic material as a result of their alignment with the varying magnetic field. In induction heating, as compared to heating by conduction, heat is generated inside the susceptor, allowing for rapid heating. Further, there need not be any physical contact between the induction heater and the susceptor, allowing for enhanced freedom in construction and application.

An induction heater may be considered as comprising a RLC circuit, comprising a resistance (R) provided by a resistor, an inductance (L) provided by an induction element (e.g. one or more coils or an electromagnet which may be arranged to inductively heat a susceptor) and a capacitance (C) provided by a capacitor, connected in series. In some cases, resistance is provided by the ohmic resistance of parts of the circuit connecting the inductor and the capacitor, and hence the RLC circuit need not necessarily include a resistor as such. Such a circuit may be referred to, for example, as an LC circuit. Such circuits may exhibit electrical resonance, which occurs at a particular resonant frequency when the imaginary parts of impedances or admittances of circuit elements are equal and opposite and hence cancel each other out.

Resonance occurs in an RLC or LC circuit when a collapsing magnetic field of an inductor generates an electric current in its windings that charges a capacitor. The capacitor then discharges providing an electric current that builds a magnetic field in the inductor. Energy is stored in an electric field whilst the capacitor is charged and in a magnetic field as current flows through the inductor. Energy can be transferred from one to the other within the circuit and this can be oscillatory in nature. When the circuit is driven at the resonant frequency, the series impedance of the inductor and the capacitor is at a minimum, and the circuit current is at a maximum. Driving the RLC or LC circuit at or near the resonant frequency may therefore provide for effective and/or efficient induction heating.

As will be understood by those skilled in the art, a transistor is a semiconductor device for switching electronic signals. A transistor typically comprises at least three terminals for connection to an electronic circuit. A field effect transistor (FET) is a specific type of transistor in which the effect of an applied electric field may be used to vary the effective conductance of the transistor.

A field effect transistor may comprise a body B, a source terminal S, a drain terminal D, and a gate terminal G. A field effect transistor comprises an active channel comprising a semiconductor through which charge carriers (e.g. electrons or holes) may flow between the source S and the drain D. The conductivity of the channel i.e. the conductivity between the drain D and the source S terminals, is a function of the potential difference between the gate G and source S terminals, for example generated by a potential applied to the gate terminal G.

One type of field effect transistors are enhancement mode FETs. It will be understood that with enhancement mode FETs, the FET will be in an OFF state (i.e. substantially preventing current from passing therethrough) when there is a substantially zero gate G to source S voltage, and the enhancement mode FET may be turned ON (i.e. substantially allowing current to pass therethrough) when there is a substantially non-zero gate G to source S voltage.

An n-channel (or n-type) field effect transistor (n-FET) is a field effect transistor whose channel comprises a n-type semiconductor, where electrons are the majority carriers and holes are the minority carriers. For example, n-type semiconductors may comprise an intrinsic semiconductor (such as silicon for example) doped with donor impurities (such as phosphorus for example). In n-channel FETs, the drain terminal D is placed at a higher potential than the source terminal S (i.e. there is a positive drain-source voltage, or in other words a negative source-drain voltage). In order to turn an n-channel FET ON (i.e. to allow current to pass therethrough), a switching potential is applied to the gate terminal G that is higher than the potential at the source terminal S.

A p-channel (or p-type) field effect transistor (p-FET) is a field effect transistor whose channel comprises a p-type semiconductor, where holes are the majority carriers and electrons are the minority carriers. For example, p-type semiconductors may comprise an intrinsic semiconductor (such as silicon for example) doped with acceptor impurities (such as boron for example). In p-channel FETs, the source terminal S is placed at a higher potential than the drain terminal D (i.e. there is a negative drain-source voltage, or in other words a positive source-drain voltage). In order to turn a p-channel FET ON (i.e. to allow current to pass therethrough), a switching potential is applied to the gate terminal G that is lower than the potential at the source terminal S (and which may, for example, be higher than the potential at the drain terminal D).

A metal-oxide-semiconductor field effect transistor (MOSFET) is a field effect transistor whose gate terminal G is electrically insulated from the semiconductor channel by an insulating layer. In some examples, the gate terminal G may be metal, and the insulating layer may be an oxide (such as silicon dioxide for example), hence “metal-oxide-semiconductor”. However, in other examples, the gate may be made from materials other than metal, such as polysilicon, and/or the insulating layer may be made from materials other than an oxide, such as other dielectric materials. Such devices are nonetheless typically referred to as metal-oxide-semiconductor field effect transistors (MOSFETs), and it is to be understood that as used herein the term metal-oxide-semiconductor field effect transistor or MOSFET is to be interpreted as including such devices.

One type of MOSFET is an n-channel (or n-type) MOSFET where the semiconductor is n-type. An n-channel MOSFET (n-MOSFET) may be operated in the same way as described above in relation to an n-channel FET. Another type of MOSFET is a p-channel (or p-type) MOSFET, where the semiconductor is p-type. A p-channel MOSFET (p-MOSFET) may be operated in the same way as described above in relation to a p-channel FET.

An n-MOSFET typically has a lower source-drain resistance than that of a p-MOSFET. It will be understood that when an n-MOSFET is in an ON state (i.e. where current is passing therethrough), then an n-MOSFET will generate less heat compared with a p-MOSFET. Accordingly, an n-MOSFET may waste less energy in operation compared to a p-MOSFET. Furthermore, n-MOSFETs typically have a shorter switching time (i.e. a characteristic response time from changing the switching potential provided to the gate terminal G to the MOSFET changing whether or not current passes therethrough) as compared to p-MOSFETs. This can allow for higher switching rates and improved switching control.

As will be described in more detail below, an H-bridge is an electronic circuit that switches the polarity of a voltage applied to a load. In the context of aerosol provision devices, an H-bridge circuit may be used to rapidly switch the direction of current flow through an inductor coil. It will be understood that by using an arrangement of MOSFETs as fast switches, the direction of current through an induction coil may be rapidly switched between a first direction and a second opposite direction. As a result, by applying a DC voltage to an H-bridge circuit comprising a number of MOSFETs an electronic circuit may be provided which allows an alternating current to pass through an induction coil. According to various embodiments, the frequency of the alternating current may be approx. 2 MHz.

As will be discussed in more detail below, the MOSFETs which are utilized in an H-bridge to supply an alternating current to an induction coil may according to various embodiments comprise enhancement type n-channel MOSFETs.

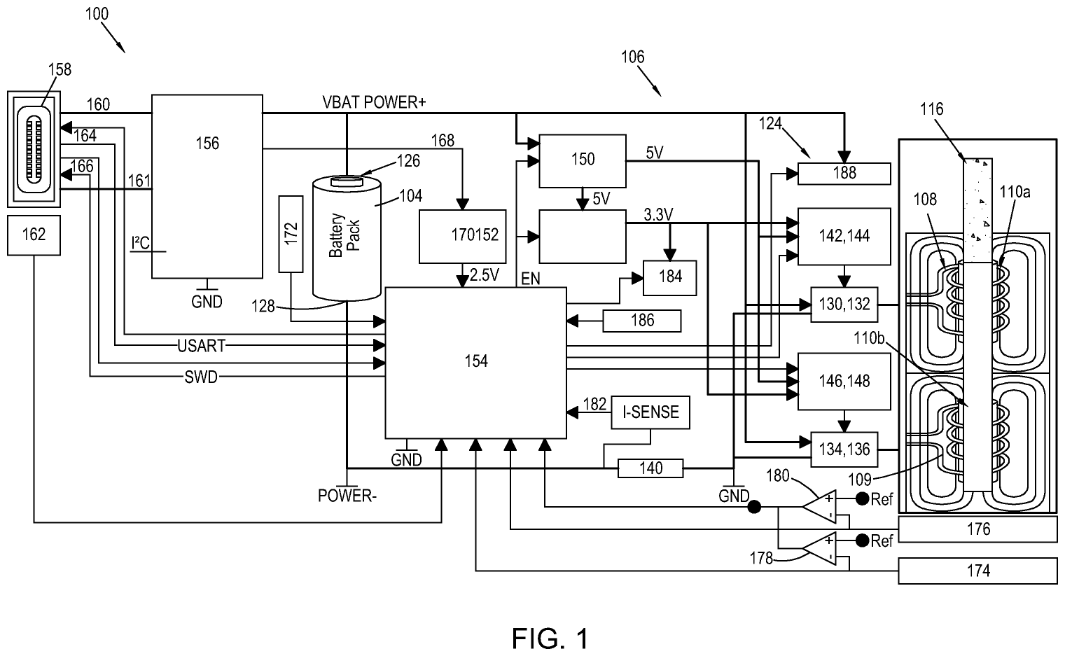

FIG. 1 illustrates schematically an electronic circuit 106 of an aerosol provision device 100. The aerosol provision device 100 comprises an aerosol generator comprising two induction heating elements 108,109 and control electronics for energizing the heating elements 108,109. The aerosol provision device 100 may comprise a single induction heating element or as shown in FIG. 1, the aerosol provision device 100 may comprise a first induction heating element 108 and a second induction heating element 109. The first induction heating element 108 may be arranged to heat, in use, a first susceptor 110a and the second induction heating element may be arranged to heat, in use, a second susceptor 110b. Alternatively, the first and second induction heating elements may be arranged to heat, in use, different portions of the same susceptor.

An aerosol generating article 116 is shown inserted into the aerosol provision device 100 and it will be understood that the aerosol generating article 116 comprises aerosol generating material which is heated, in use, by the first and second susceptors 110a, 110b. It will be understood that the first and second susceptors 110a, 110b are heated due to an electric current being induced within the susceptors 110a, 110b. The first and second susceptors 110a, 110b may comprise a ferromagnetic portion, which may comprise a metal such as iron, nickel or cobalt. When an alternating current is driven through either the first and/or second induction elements 108,109 the alternating current will cause the corresponding first and/or second susceptor 110a, 110b to heat up by Joule heating and/or by magnetic hysteresis heating, as described above. Accordingly, it will be understood that the electronic circuit 106 is arranged to pass an alternating electric current to the first and second induction elements 108,109 which in turn induces a corresponding electric current in the first and second susceptors 110a, 110b which causes the susceptors 110a, 110b to become hot and hence to heat aerosol generating material (which is provided as a part of the aerosol generating article 116).

A DC power source 104 is provided which forms part of the electronic circuit 106. The DC power source 104 may comprise a battery or battery pack. The DC power source 104 is arranged to provide DC electrical power to the electronic circuit 106. The electronic circuit 106 is electrically connected to the first and second induction elements 108,109. Each of the induction elements 108,109 may comprise, for example, an electromagnet including one or more coils or solenoids. The first and second induction elements 108,109 may be formed from copper wire. The electronic circuit 106 is arranged to convert a DC current provided by the DC power source 104 into an alternating current which is provided to the first and second induction elements 108,109. The electronic circuit 106 is arranged to drive the alternating current through the first and second induction elements 108,109 at a relatively high frequency e.g. approx. 2 MHz.

The first and second susceptors 110a, 110b are arranged relative to the first and second induction heating elements 108,109 for inductive energy transfer from the first and second induction heating elements 108,109 to the first and second susceptors 110a, 110b. When an alternating current is driven through either the first and/or second induction elements 108, 109 the alternating current will cause the corresponding first and/or second susceptors 110a, 110b to heat up by Joule heating and/or by magnetic hysteresis heating. The first and/or second susceptors 110a, 110b are arranged to heat aerosol generating material which is provided as part of the aerosol generating article 116 e.g. by conduction, convection and/or radiation heating, in order to generate an aerosol in use.

The first and/or second susceptors 110a, 110b may form part of the aerosol provision device 100. Alternatively, the first and/or second susceptors 110a,110b and the aerosol generating material may be arranged to form an integral unit or consumable which may be inserted and/or removed from the aerosol provision device 100 and wherein the integral unit or consumable may be disposable. In some examples, the first and second induction elements 108,109 may be removable from the aerosol provision device 100, for example for replacement. The aerosol provision device 100 may be hand-held. The aerosol provision device 100 may be arranged to heat the aerosol generating material in order to generate aerosol for inhalation by a user.

It is noted that, as used herein, the term “aerosol generating material” includes materials that provide volatilized components upon heating, typically in the form of vapor or an aerosol. Aerosol generating material may be a non-tobacco-containing material or a tobacco-containing material. For example, the aerosol generating material may be or comprise tobacco. Aerosol generating material may, for example, include one or more of tobacco per se, tobacco derivatives, expanded tobacco, reconstituted tobacco, tobacco extract, homogenised tobacco or tobacco substitutes. The aerosol generating material can be in the form of ground tobacco, cut rag tobacco, extruded tobacco, reconstituted tobacco, reconstituted material, liquid, gel, gelled sheet, powder, or agglomerates, or the like. Aerosol generating material also may include other, non-tobacco products which depending on the product, may or may not contain nicotine. Aerosol generating material may comprise one or more humectants, such as glycerol or propylene glycol.

The aerosol provision device 100 may comprise an outer body (not shown) which may be arranged to house the DC battery 104, the electronic circuit 106, the first and second induction elements 108,109 and optionally also the first and second susceptors 110a, 110b. The outer body may comprise a mouthpiece to allow aerosol generated in use to exit the aerosol provision device 100.

In use, a user may activate the electronic circuit 106 by, for example, activating a button or via a puff detection component (not shown) in order to cause an alternating current to be driven through the first and second induction elements 108,109, thereby inductively heating the first and second susceptors 110a, 110b which in turn will result in heating of the aerosol generating material so as to cause an aerosol to be generated. The aerosol may be generated and mixed with air which may be drawn into the aerosol provision device 100 via an air inlet (not shown). The mixture of aerosol and air may then be directed towards the mouthpiece where the aerosol then exits the aerosol provision device 100 and may be inhaled by a user.

The aerosol provision device 100 comprising the electronic circuit 106 and first and second induction elements 108,109 in combination with the first and second susceptors 110a, 110b may be arranged to heat the aerosol generating material to a range of temperatures in order to volatilize at least one component of the aerosol generating material without combusting the aerosol generating material. For example, according to various embodiments the aerosol generating material may be heated to a temperature in the range 50-100° C., 100-150° C., 150-200° C., 200-250° C., 250-300° C. or >300° C.

The DC power source 104, which may comprise a battery pack, may be connected to a driver arrangement 124 for supplying electrical energy to the first and second induction elements 108,109 which may comprise two coils. The driver arrangement 124 may be connected to a positive terminal 126 of the battery pack 104 that provides a relatively high electric potential and to a negative terminal 128 of the battery pack 104 or to ground GND which provides a relatively low, zero or negative electric potential. A voltage is therefore established across the driver arrangement 124.

For illustrative purposes, the driver arrangement 124 comprises a first full H-bridge driver circuit 142,144 which is coupled to two dual MOSFETs 130,132 for supplying an alternating current to a first induction element 108. The two dual MOSFETs 130,132 may each comprise an enhancement type n-channel MOSFET.

The driver arrangement 124 further comprises a second full H-bridge driver circuit 146,148 which is coupled to two further dual MOSFETs 134,136 for supplying an alternating current to a second induction element 109. The two further dual MOSFETs 134,136 may each comprise enhancement type n-channel MOSFETs. Accordingly, the overall driver arrangement may comprise eight MOSFETS 130,132,134,136 which may comprise enhancement type n-channel MOSFETs.

It will be understood, therefore, that the arrangement shown in FIG. 1 is given for illustrative purposes only in order to illustrate how two induction elements may each be driven by a separate full H-bridge driver circuit 130,132,134,136.

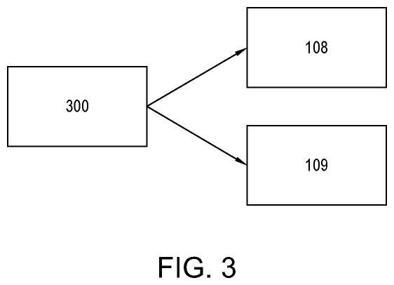

However, as will be discussed in more detail with reference to FIG. 3 below, according to various embodiments an electronic circuit is provided wherein the arrangement shown in FIG. 1 is modified so that a single full H-bridge driver circuit in combination with a switching element is provided. As a result, according to various embodiments, one of the two full H-bridge driver circuits 130, 132, 134, 136 as shown in FIG. 1 becomes redundant and instead only one of the two full H-bridge 130,132, 134, 136 as shown in FIG. 1 may be provided in combination with a switching element (not shown in FIG. 1).

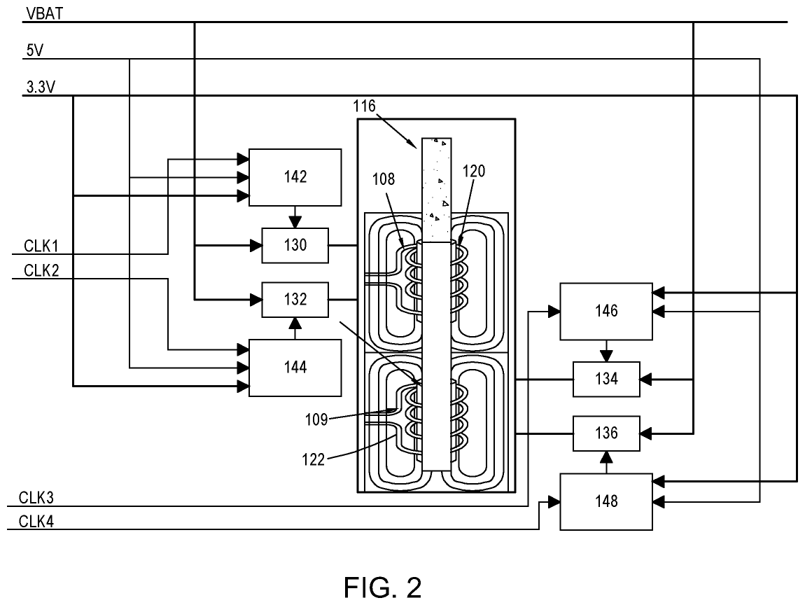

With reference to FIG. 2, the electronic circuit 106 which is disclosed for illustrative purposes is shown comprising a first full H-bridge which comprises a pair of MOSFETs 130 (driven by a first H-bridge driver circuit 142) connected to a first terminal of a first induction element 108 and a pair of MOSFETs 132 (driven by a second H-bridge driver circuit 144) connected to a second terminal of the first induction element 108. The first induction element 108 may comprise a first induction coil 120.

A second full H-bridge is provided which comprises two MOSFETs 134 (driven by a third H-bridge driver circuit 146) connected to a first terminal of a second induction element 109 and two MOSFETs 136 (driven by a fourth H-bridge driver circuit 148) connected to a second terminal of the second induction element 109. The second induction element 109 may comprise a second induction coil 122.

In view of the comments made above in relation to FIG. 1, it should be understood that FIG. 2 is disclosed for illustrative purposes in order to illustrate how a full H-bridge driver circuit may be connected to the terminals of an induction element in order to supply an alternating current to the induction element.

As will be understood, according to various embodiments a single H-bridge driver circuit is provided in combination with a switching element. It will be apparent that the approach according to various embodiments of utilizing a single H-bridge driver element in combination with a switching element reduces the footprint of a PCB compared to a PCB which may be utilized to implement the electronic circuit shown in FIG. 2.

For illustrative purposes it will be understood that each pair of MOSFETS 130, 132, 134, 136 shown in FIG. 2 may be connected to the high electric potential VBAT or VBAT POWER+ of the battery pack 104 and to the negative electric potential POWER− or GND (as shown in FIG. 1 but omitted from FIG. 2). With reference to FIG. 1, a resistor 140 (e.g. 2 mΩ) may be provided in the connection line between the battery pack 104 and the pairs of MOSFETs 130,132, 134, 136.

Accordingly, the driver arrangement 124 as shown in FIG. 1 may comprise a first H-bridge driver circuit 142, a second H-bridge driver circuit 144, a third H-bridge driver circuit 146 and a fourth H-bridge driver circuit 148. The driver circuits 142,144,146,148 are arranged to drive each of the switching elements or pairs of MOSFETs 130,132,134,136 i.e. to control each pair of MOSFETs 130, 132,134, 136 to be in either a conducting state or in a non-conducting state in order to change the direction of current between the terminals of the induction elements 108,109.

As shown in more detail in FIG. 2, the four driver circuits 142, 144, 146, 148 may be provided with a bias or supply voltage of, for example, 5 V. The required value may vary depending on the specific driver. This supply voltage may be obtained from the high electric potential VBAT POWER+ (FIG. 1) or VBAT (FIG. 2) from the battery pack 104 or via a buck boost regulator or DC-to-DC converter 150 or another suitable regulator.

The aerosol provision device 100 may be operated in a first, normal or standard mode of operation and also in a second or boost mode operation. When the aerosol provision device 100 is operated in a second or boost mode of operation it may be desired to increase the temperature of one or both susceptors 110a, 110b e.g. to increase the temperature profile. In the second mode or boost mode of operation a 5V DC may be supplied to the driver circuits 142, 144, 146, 148.

In the first mode of operation the drivers 142, 144,146, 148 may be provided with a lower voltage of e.g. 3.3 V. This supply voltage can be obtained from the 5 V of the buck boost regulator or DC-to-DC converter 150 via a voltage regulator 152. The voltage regulator 152 may comprise a low drop-out (LDO) regulator.

Thus, the driver arrangement 124 is arranged to provide, from an input direct current from the battery pack 104, an alternating current to the coils 120, 122 or their respective LC circuit for driving the first and second induction elements 108, 109 or coils 120, 122 in use.

With reference to FIG. 1, a central controlling unit 154 such as a microcontroller unit (“MCU”) may be provided. The central controlling unit 154 serves as a controller for the driver circuits 142, 144, 146, 148 i.e. the central controlling unit 154 may be arranged to control the circuits 142,144,146,148 by, for example, providing a pulse-width modulation (“PWM”) signal to the driver circuits 142,144,146,148, wherein the driver circuits 142,144,146,148 in turn control the dual MOSFETs 130,132, 134,136.

The central controlling unit 154 may be arranged to set a frequency at which the dual MOSFETs 130,132,134,136 are switched between a conducting state or a non-conducting state. As a result, the central controlling unit 154 is effectively arranged to set the frequency of an alternating current which is applied to the induction elements 108,109.

According to various embodiments, the central controlling unit 154 may be arranged to determine the resonant frequency f0 of an induction element 108,109. Furthermore, the central controlling unit 154 may be arranged to supply an alternating current to the induction elements 108,109 at, for example, a first frequency f1 which is within 10% of the resonant frequency f0. The central controlling unit 154 may also be arranged to supply an alternating current to the induction elements 108,109 at, for example, a second frequency f2 which is either at least 10% below the resonant frequency f0 or at least 10% above the resonant frequency f0.

The central controlling unit 154 may also control various other functions and components of the electronic circuit 106. For example, the central controlling unit 154 may control the buck boost regulator or DC-to-DC converter 150 and the voltage regulator 152 so that a voltage of either 5V (boost mode) or 3.3 V (normal mode) is supplied to the driver circuits 142, 144,146, 148.

As shown in FIG. 1, the electronic circuit 106 may also comprise a battery charging circuit 156 which may be connected to the battery pack 104 at the positive terminal 126 and also to ground GND. The battery charging circuit 156 may be connected to an interface 158 such as an USB interface, for example, via a positive connection line 160 for high electric potential and a corresponding negative connection line 161. This allows connection of a plug of a power supply, for example, to the aerosol provision device 100 in order to charge or re-charge the battery pack 104.

A USB temperature sensor 162 such as a Negative Temperature Coefficient (“NTC”) temperature sensor may be located at the interface 158 and may be connected to the central controlling unit 154. The USB temperature sensor 162 allows the temperature of the interface 158 to be monitored and for charging of the battery 104 to be controlled. For example, charging may be interrupted if the temperature of the interface 158 is determined to be a temperature above a maximum desired temperature threshold.

A data connection line 164 such as a Universal Synchronous/Asynchronous Receiver Transmitter (“USART”) or other type of connection may be provided between the interface 158 and the central controlling unit 154. This allows data exchange between the central controlling unit 154 and an external device connected to the aerosol provision device 100 via the interface 158, for example, for controlling charging. Both data transfer directions are indicated via two lines with arrows in FIG. 1 with one from the central controlling unit 154 to the interface 158 and one from the interface 158 to the central controlling unit 154.

A debugging connection line 166 such as a Serial Wire Debug (“SWD”) or other type of connection line may be provided between the interface 158 and the central controlling unit 154. The debugging connection line 166 allows debugging of the central controlling unit 154 via an external device connected to the aerosol provision device 100 via the connector or interface 158. Both data transfer directions are indicated via two lines with arrows, one from the central controlling unit 154 to the interface 158 and one from the interface 158 to the central controlling unit 154.

The battery charging circuit 156 may be arranged to provide power to the central controlling unit 154 via power line 168. For example, the central controlling unit 154 might be supplied with a voltage of 2.5V. A voltage regulator 170 of any suitable type might be used to generate the required supply voltage for the central controlling unit 154.

According to various embodiments a battery temperature sensor 172 such as a NTC temperature sensor may be provided at the battery pack 104 and may be connected to the central controlling unit 154. The battery temperature sensor 172 allows the temperature of the battery pack 104 to be monitored and enables charging of the battery pack 104 to be controlled. For example, charging may be interrupted if the battery pack 104 is determined to be at too high a temperature. Furthermore, regular operation of the aerosol provision device 100 may be controlled based upon the determined temperature of the battery pack 104.

A temperature sensor 174 such as a NTC temperature sensor may be provided adjacent the first and second induction elements 108, 109 or the respective coils 120, 122 and may be connected to the central controlling unit 154. According to various embodiments a thermocouple temperature sensor 176 may also be provided. In particular, each coil 120,122 may be monitored by a separate thermocouple 176 and one or both thermocouples 176 may be connected to the central controlling unit 154. A reference voltage Ref may be provided to a first comparator 178 coupled to the temperature sensor 174. Similarly, a reference voltage Ref may be provided to a second comparator 180 coupled to the thermocouples180. The comparators 178, 180 may be provided in order to achieve measurable voltages thereby enabling monitoring of the temperatures of the coils 120, 122 or the respective induction element 108,109 to be achieved and for their operation to be controlled. For example, the operating frequency of an alternating current applied to the induction elements 108,109 may be changed, varied, increased or decreased depending upon the determined temperature of the induction elements 108,109 or coils 120,122. For example, as will be understood by those skilled in the art, the resonant frequency fo of the coils 120,122 or the induction elements 108, 109 may change with temperature. For example, as the temperature of the induction elements 108,109 increases with time then the resonant frequency f0 of the induction elements 108,109 or coils 120, 122 may decrease with time.

The central controlling unit 154 may be configured to measure the current supplied to the induction elements 108,109 or coils 120,122 by the dual MOSFETs (switches) 130, 132, 134, 136. For example, a current sensing component I_SENSE may be provided in a line which is connected between the MOSFETs 130,132, 134, 136 and/or the H-bridge driver circuits 142,144, 146, 148 and the negative terminal 128 at the resistor 140. An analogue-to-digital converter (“ADC”) 182 may be used to convert the determined current into a digital voltage level which is provided to the central controlling unit 154.

An indication light 184 (e.g. a LED) may be provided in order to indicate one of several operating states of the aerosol provision device 100. The LED 184 may comprise a RGB LED i.e. a LED capable of providing illumination across the entirety of the visible color spectrum or only parts thereof. For example, the LED 184 may be illuminated to display red, green, blue, white and a variety of different hues. The indication light 184 may be supplied with power via voltage regulator 152 and may be controlled by the central controlling unit 154. The indication light 184 may be provided as part of a user interface located on an outer portion of the aerosol provision device 100.

A button or key 186 may be provided e.g. on the outer housing of at the aerosol provision device 100. The button or key 186 may be used for changing an operating mode of the aerosol provision device 100 or to switch power ON or OFF or the like. The button or key 186 may be connected to the central controlling unit 154 which receives signals provided by the button or key 186 being operated and may implement the required operation change, for example.

A haptic motor 188 or any other haptic feedback element may be provided. The haptic motor 188 may be supplied with power from the battery back 104 and may be controlled by the central controlling unit 154. This allows a user of the aerosol provision device 100 to receive haptic feedback during use.

The central controlling unit 154 or the driver controller part thereof may be arranged to control the frequency of the alternating current which is provided to the coils 120,122 or the LC circuit comprising the coils, via the driver arrangement 124 and hence the frequency of the alternating current driven through the induction element 108,109 or coils 120,122. The induction elements 108,109 or respective coils 120,122 may be operated in various mode of operation wherein only one or both induction elements 108,109 are energized at any particular point in time.

As mentioned above, the LC circuits may exhibit resonance. The central controlling unit 154 or the driver controller part thereof may control the frequency of the alternating current driven through the coils or the LC circuit (i.e. the drive frequency) in order to be at or near the resonant frequency of the one or both of the coils 120,122 or the LC circuit. For example, the drive frequency may be in the MHz range, for example in the range 0.5 to 1.5 MHz e.g. 1 MHz. Other embodiments are contemplated wherein the drive frequency may be in the range 1-2 MHz. It will be appreciated that other frequencies may be used, for example, depending on the particular coils or LC circuit (and/or components thereof), and/or susceptors 110a, 110b utilized. For example, it will be appreciated that the resonant frequency f0 of the LC circuit may be dependent upon the inductance L of the coils 120,122 and the capacitance C of the circuit, which in turn may be dependent upon the inductor elements 108,109, capacitor and susceptors 110a, 100b used.

In use, when the central controlling unit 154 or the driver controller part thereof is activated, for example by a user, the central controlling unit 154 or the driver controller part thereof may control the driver arrangement 124 to drive an alternating current through one or more of the coils 120, 122 or the LC circuit and hence through the induction elements 108,109 thereby causing induction heating of the susceptors 110a, 110b. As the susceptors 110a, 110b become hot, they may heat aerosol generating material which forms part of the aerosol generating article 116 and as a result aerosol may be generated for inhalation by a user.

Referring to FIG. 2, there is illustrated schematically in more detail part of the electronic circuit 106 of the aerosol provision device 100 of FIG. 1. As described above with reference to FIG. 1, the driver arrangement may comprise an H-bridge configuration comprising two full H-bridges, one per coil 120,122. Each full H-bridge comprises four switching elements which may comprise transistors or pairs of MOSFETs 130,132,134,136. The four pairs of MOSFETs 130,132, 134, 136 may be provided as two dual MOSFETs per full H-bridge. The dual MOSFETs 130,132,134,136 are shown in FIG. 2 and two pairs of MOSFETs 130,132,134,136 are provided per coil 120,122. Each pair of MOSFETs 130,132,134,136 is connected to the high electric potential VBAT POWER+ or VBAT of the battery pack and to the negative electric potential POWER− or GND (not shown here).

Accordingly, two half H-bridge drivers 142,144; 146, 148 are provided per full H-bridge or per pair of dual MOSFETs 130,132,134,136. The H-bridge drivers 142,144;146,148 may be provided with a bias or supply voltage of, for example, 5 V (e.g. in a boost mode of operation) and with a control or supply voltage of, for example, 3.3 V (e.g. during a standard mode of operation) as described above.

As also described above with reference to FIG. 1, a central controlling unit such as a MCU 154 serves as a controller for the drivers 142,144, 146,148 i.e. the MCU 154 may be arranged to control the drivers 142,144,146,148 and to provide the drivers 142,144,146,148 with a clock signal. For example, a first clock signal CLK1 may be provided to the first driver 142 and a second clock signal CLK2 may be provided to the second driver 144 wherein the drivers 142,144 are arranged to drive pairs of MOSFETs 130,132 connected to the first coil 120. A third clock signal CLK3 may be provided to the third driver 146 and a fourth clock signal CLK4 may be provided to the fourth driver 148 wherein the drivers 146,148 are arranged to drive pairs of MOSFETs 134,136 connected to the second coil 122.

FIG. 3 illustrates an electronic circuit 300 according to various embodiments. The electronic circuit 300 comprises a driver arrangement which is arranged to supply an alternating current to an aerosol generator comprising one or more first induction elements 108 and one or more second induction elements 109. The driver arrangement comprises a full H-bridge driver circuit. The full H-bridge driver circuit may comprise four MOSFETs. The MOSFETs which are utilized in the full H-bridge driver circuit may comprise enhancement type n-channel MOSFETs.

According to various embodiments the output from the full H-bridge driver circuit is connected to a switch element which forms part of the electronic circuit 300. The switch element may be arranged to switch the alternating current supplied by the driver arrangement to either the one or more first induction elements 108 or the one or more second induction elements 109. The switch element may comprise a MOSFET. For example, the switch element may comprise an enhancement type n-channel MOSFET.

According to a mode of operation during a session of use the switch element may be arranged to energize the one or more first induction elements 108 initially and then later on during the session the switch element may be arranged to energize the one or more second induction elements 109. Alternatively, according to another mode of operation during a session of use the switch element may be arranged to energize the one or more second induction elements 109 initially and then later on during the session the switch element may be arranged to energize the one or more first induction elements 108.

According to other embodiments, during a session of use the switch element may be arranged to repeatedly switch between providing an alternating current to the one or more first induction elements 108 and to the one or more second induction elements 109. During a session of use the ratio of time spent energizing the one or more first induction elements 108 and to the one or more second induction elements 109 may be equal e.g. 50%/50%. However, other embodiments are contemplated the ratio of time spent energizing the one or more first induction elements 108 is greater than the time spent energizing the one or more second induction elements 109 e.g. 60%/50%, 70%/30%, 80%/20% or 90%/10%. Alternatively, other embodiments are contemplated wherein the ratio of time spent energizing the one or more first induction elements 108 is less than the time spent energizing the one or more second induction elements 109 e.g. 40%/60%, 30%/70%, 20%/80% or 10%/90%.

It will be understood that according to various embodiments that only a single full H-bridge driver circuit is required in order to supply an alternating current to both the one or more first induction elements 108 and also the one or more second induction elements 109. The one or more first induction elements 108 and the one or more second induction elements 109 may comprise one or more induction coils.

In order to address various issues and advance the art, this disclosure shows by way of illustration various embodiments. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. An electronic circuit for an aerosol generator of an aerosol provision device comprising:
a driver arrangement arranged in a H-bridge configuration for supplying an alternating current to an aerosol generator comprising one or more first induction elements and one or more second induction elements; and
a switch element arranged to switch the alternating current supplied by the driver arrangement to either the one or more first induction elements or the one or more second induction elements.

2. An electronic circuit as claimed in claim 1, wherein the switch element comprises a MOSFET.

3. An aerosol provision device comprising:
an electronic circuit as claimed in claim 1.

4. An aerosol provision device as claimed in claim 3, further comprising an aerosol generator.

5. An aerosol provision device as claimed in claim 4, wherein the aerosol generator comprises one or more first induction elements and one or more second induction elements.

6. An aerosol provision device as claimed in claim 5, wherein the one or more first induction elements comprises one or more induction coils.

7. An aerosol provision device as claimed in claim 5, wherein the one or more second induction elements comprises one or more induction coils.

8. An aerosol generating system comprising:
an aerosol provision device as claimed in claim 3; and
an aerosol generating article comprising aerosol generating material.

9. A method of generating an aerosol comprising:
providing an aerosol provision device as claimed in claim 3;
inserting an aerosol generating article comprising aerosol generating material into the aerosol provision device; and
energizing the aerosol generating article.

10. An electronic circuit as claimed in claim 1, wherein the circuit is configured to provide the driver arrangement with a first lower voltage for operating the aerosol provision device in a normal mode, and a second higher voltage for operating the aerosol provision device in a boost mode.
